(19) United States
(12) Patent Application Publication
(10) Pub. No.: US 2005/0200673 A1
(43) Pub. Date: Sep. 15, 2005

(54) Printer

(75) Inventor: Wataru Sasaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/078,488

(22) Filed: Mar. 14, 2005

(30) Foreign Application Priority Data
Mar. 15, 2004 (JP) 2004-072792

(51) Int. Cl. B41J 2/01

(52) U.S. Cl. 347/101

(57) ABSTRACT

A motor drive section and MPU supply power from primary batteries directly to a DC motor to achieve a predetermined initial transport speed and high delivery transport speed. Also, they convert the power of the primary batteries into a predetermined voltage lower than the voltage of the primary batteries and supply the resulting voltage to the DC motor to achieve a low writing transport speed. They control the rotational speed of the DC motor so that pulse trains of an encoder signal from an ENCPI section are generated at predetermined time intervals while an instant film sheet is being transported at the writing transport speed, and sends out the instant film sheet at high delivery transport speed when writing is completed.

### BACKGROUND OF THE INVENTION

1. Field of the Invention

The present invention relates to a printer which writes images on a recording medium while transporting the recording medium on which images are to be recorded.

2. Description of the Related Art

Printers of the type described above include a printer which writes color images on an instant film sheet. The printer has a fixed write head which writes an image on the instant film sheet being transported, at a fixed write point. While a motor is feeding the instant film sheet in a sub-scanning direction, the fixed write head cyclically writes to the instant film sheet in the sub-scanning direction using red (R), green (G), and blue (B) luminescent colors from light-emitting elements in quantities corresponding to image data based on write command pulses synchronized with the rotation of the motor. This allows the printer to record a color image on the instant film sheet. A printer has been proposed which generates dummy pulses if write command pulses are not generated for some reasons (Japanese Patent Application Publication No. 2002-67392).

With the conventional printers which write images on a recording medium while transporting the recording medium on which images are to be recorded, including the printer proposed in Japanese Patent Application Publication No. 2002-67392, the recording medium should be transported not faster than at a predetermined speed in order to be exposed sufficiently. On the other hand, there are demands that a sequence should be completed as quickly as possible.

### SUMMARY OF THE INVENTION

The present invention has been made in view of the above circumstances and provides a printer which can reduce the time required to produce a print while maintaining the quality of images written into a recording medium.

To achieve the above object, the present invention provides a printer which writes images on a recording medium while transporting the recording medium on which the images are to be recorded, having:
a fixed write head which writes an image on the recording medium being transported, at a predetermined fixed write point;
a media transport section which transports the recording medium from a predetermined transport start point to a predetermined transport end point through the fixed write point; and
a transport control section which controls the media transport section so that the recording medium located at the transport start point starts to be transported at an initial transport speed, that transport speed is changed to a low writing transport speed before a predetermined writing start point on the recording medium reaches the fixed write point, and that the transport speed of the recording medium is changed again to a delivery transport speed higher than the writing transport speed after a predetermined writing end point on the recording medium passes the fixed write point.

The printer according to the present invention starts to transport the recording medium located at the transport start point at an initial transport speed, changes the transport speed to a low writing transport speed before a predetermined writing start point on the recording medium reaches the fixed write point, changes the transport speed again to a high delivery transport speed after the writing is completed, and then outputs the recording medium. Consequently, the recording medium is transported at a high speed until the writing is started, then it starts to be transported at a low speed just before the writing is started so that the image is written into it reliably, and then it is sent out at a high speed. This reduces the time required to produce a print while maintaining the quality of images written into the recording medium.

Preferably, the recording medium is transported by a DC motor which draws power from built-in batteries; and
the transport control section develops the initial transport speed and the delivery transport speed by supplying power directly to the DC motor from the built-in batteries and develops the writing transport speed by converting the power of the built-in batteries into a predetermined voltage lower than voltage of the built-in batteries and supplying the resulting voltage to the DC motor.

This makes it possible to reduce the time required to produce a print while maintaining the quality of images written into the recording medium using an inexpensive DC motor instead of an expensive stepping motor.

The built-in batteries are often primary batteries, and to increase the number of available prints, it is necessary to use the batteries until close to the end of their available life, i.e., until their voltage falls. The most effective method is the one that develops the writing transport speed at a voltage lower than the battery voltage as is the case with the present invention.

Also, preferably, the transport control section has an integration circuit including a resistor and capacitor, provides a pulse train signal with a variable duty ratio to the integration circuit, and supplies the DC motor with power proportional to DC voltage obtained through integration carried out by the integration circuit while the recording medium is transported at the writing transport speed.

Since power proportional to DC voltage can be supplied to the DC motor using an inexpensive integration circuit, it is possible to reduce costs.

Furthermore, the media transport section has a transport roller which rotates to transport the recording medium, being driven by the DC motor, and an encoder which generates an encoder signal consisting of pulse trains in synchronization with the rotation of the transport roller; and
the transport control section preferably controls rotational speed of the DC motor so that the pulse trains of the encoder signal is generated at predetermined time intervals while the recording medium is transported at the writing transport speed.

This makes it possible to control the rotational speed of the DC motor using a simple configuration.

Also, preferably, the printer has a media compartment loaded with a recording medium on which a latent image is formed by exposure and then visualized by developing,
wherein the media transport section transports the recording medium loaded in the media compartment, which serves as the transport start point; and
the fixed write head writes a latent image into the recording medium by irradiating the recording medium being transported, with multiple color lights cyclically.

This configuration reduces the time required to produce a print while maintaining the quality of images written onto instant film sheets on the printer loaded with an instant film pack containing a stack of instant film sheets for instant photography.

The printer according to the present invention reduces the time required to produce a print while maintaining the quality of images written into a recording medium.

### BRIEF DESCRIPTION OF THE DRAWINGS

FIG. 1 is a perspective view of a printer according to an embodiment of the present invention as viewed obliquely from the front;

FIG. 2 is a diagram showing how the printer shown in FIG. 1 ejects an instant film sheet on which an image is recorded based on image data received from a camera-equipped cell phone;

FIG. 3 is a perspective view of the underside of the printer in FIG. 1 as viewed obliquely from above;

FIG. 4 is a perspective view of the printer in FIG. 3 with its film door open;

FIG. 5 is a block diagram showing a control system in the printer;

FIG. 6 is a sectional view showing a configuration of part of a media transport section;

FIG. 7 is a perspective view of the media transport section

FIG. 8 is a diagram showing a circuit of the motor drive section shown in FIG. 5; and

FIG. 9 is timing charts of the motor drive section shown in FIG. 8 and the MPU.

### DETAILED DESCRIPTION OF THE INVENTION

An embodiment of the present invention will be described below.

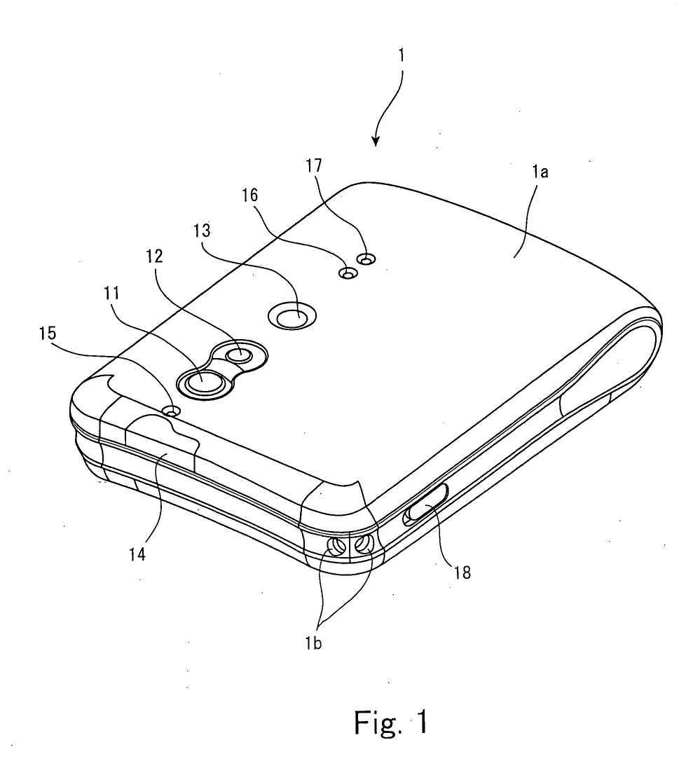

FIG. 1 is a perspective view of a printer according to an embodiment of the present invention as viewed obliquely from the front.

The printer 1 writes images on a recording medium while transporting the recording medium on which the images are to be recorded. Specifically, the printer 1 is used in combination with a cell phone or the like. A media compartment is loaded with an instant film pack containing a stack of instant film sheets (ten sheets in this case) on which a latent image is formed by exposure and then visualized by a developer during delivery. An instant film sheet is exposed according to image data and the developer is applied to it while the instant film sheet is being sent out. The instant film sheet is an example of the recording medium according to the present invention. Although the instant film sheet is used here as the recording medium, the printer may use plain paper.

Some cell phones are capable of infrared communication compliant with IRDA (InfraRed Data Association). They can send their own information to other information devices using infrared communication. For example, a camera-equipped cell phone can send image data to the printer 1. Upon receiving image data of images taken by a camera-equipped cell phone or image data attached to mail sent to the cell phone through infrared communication, the printer 1 records images on instant film sheets based on the image data. Furthermore, images based on the received image data can be recorded again on other film sheets by simply pressing a repeat switch (described later) without the trouble of re-transmitting the image data from the cell phone.

As shown in FIG. 1, the printer 1 is a portable printer with a thin, lightweight, and small structure. It contains two 3-volt primary batteries. An instant film pack is loaded in a housing 1a of the printer 1 and an image is recorded on each of the ten instant film sheets contained in the instant film pack.

Operation buttons are provided on the top face of the housing 1a of the printer 1: a power switch (hereinafter referred to as the power SW) 11 used to turn on and off the printer 1 and a repeat switch (hereinafter referred to as the repast SW) 12 used to re-record images based on transmitted image data. Also, a counter 13 which indicates the number of remaining instant film sheets is provided on the top face of the housing 1a. The counter 13 is a mechanical one which displays a numeric value of “10” when a new instant film pack is loaded, indicating that the number of remaining instant film sheets is 10. Subsequently, the number is decremented by one each time an image is recorded on an instant film sheet until an image is recorded on the tenth instant film sheet and a numeric value of “0” is displayed indicating that the number of remaining instant film sheets is 0. Incidentally, when the instant film pack is pulled out, the counter 13 becomes blank, displaying nothing.

An end of the printer 1 is equipped with a receiver/transmitter section 14 to receive image data transmitted through infrared communication and send a signal notifying the partner about the reception.

Furthermore, the housing 1a of the printer 1 is equipped with a power LED 15 which glows when the printer 1 is turned on and blinks during infrared communication, communications error LED 16 which glows in case of error in infrared communication, and a low-battery indicator LED 17 which glows when the built-in batteries get low, prompting the user to replace the batteries.

Also, a film door opening switch 18 is provided on a flank of the printer 1 to open a film door (described later) installed on the underside of the printer 1 while a strap mount 1b is provided at a corner.

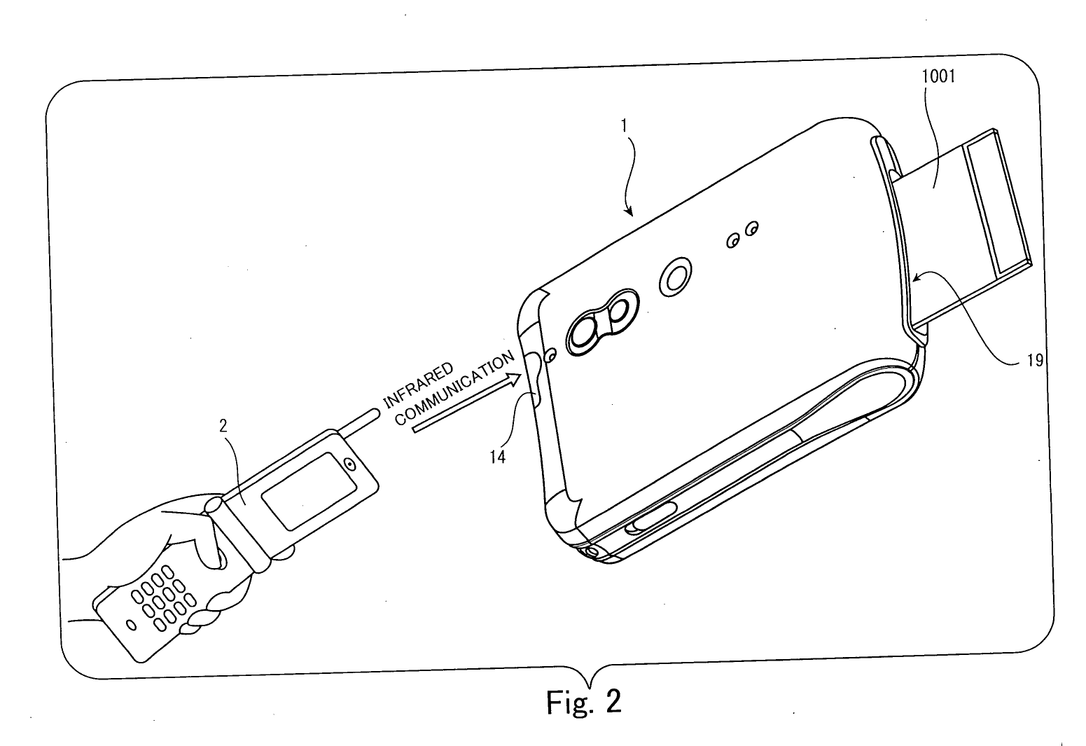

FIG. 2 is a diagram showing how the printer shown in FIG. 1 ejects an instant film sheet on which an image is recorded based on image data received from a camera-equipped cell phone.

With an infrared communications section of a camera-equipped cell phone 2 directed at the receiver/transmitter section 14, the user operates the camera-equipped cell phone 2 to send image data of an image taken by the camera-equipped cell phone 2 to the printer 1 through infrared communication. The printer 1 receives the image data transmitted through infrared communication, records a latent image based on the received image data on an instant film sheet 1001 by exposure, develops the instant film sheet 1001, and ejects the instant film sheet 1001 gradually through an output port 19 of the printer 1. Subsequently, if the repeat SW 12 is pressed, the same image is re-recorded on another instant film sheet.

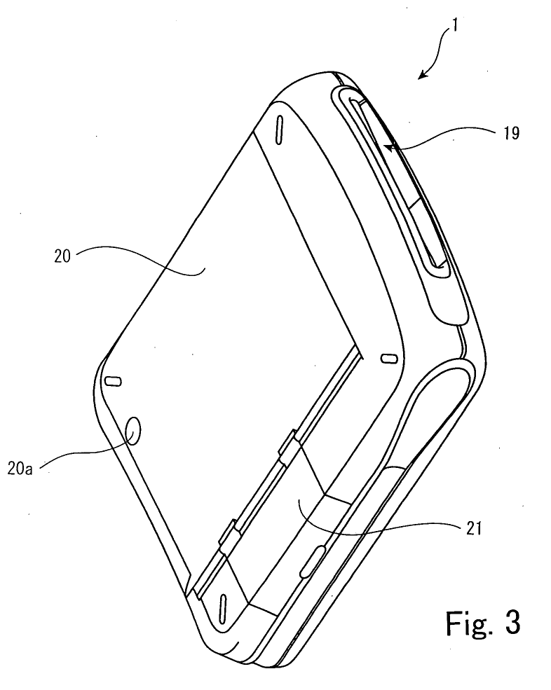

FIG. 3 is a perspective view of the underside of the printer in FIG. 1 as viewed obliquely from above.

On the underside of the printer 1, there is a film door 20 which is opened by means of the film door opening switch 18 shown in FIG. 1. An instant film pack is loaded in the media compartment through the opened film door 20. Also, a pack confirmation window 20a is provided on the film door 20 to check whether an instant film pack has been loaded. Besides, a battery lid 21 is provided next to the film door 20. It is opened to mount batteries which supply power to the printer 1.

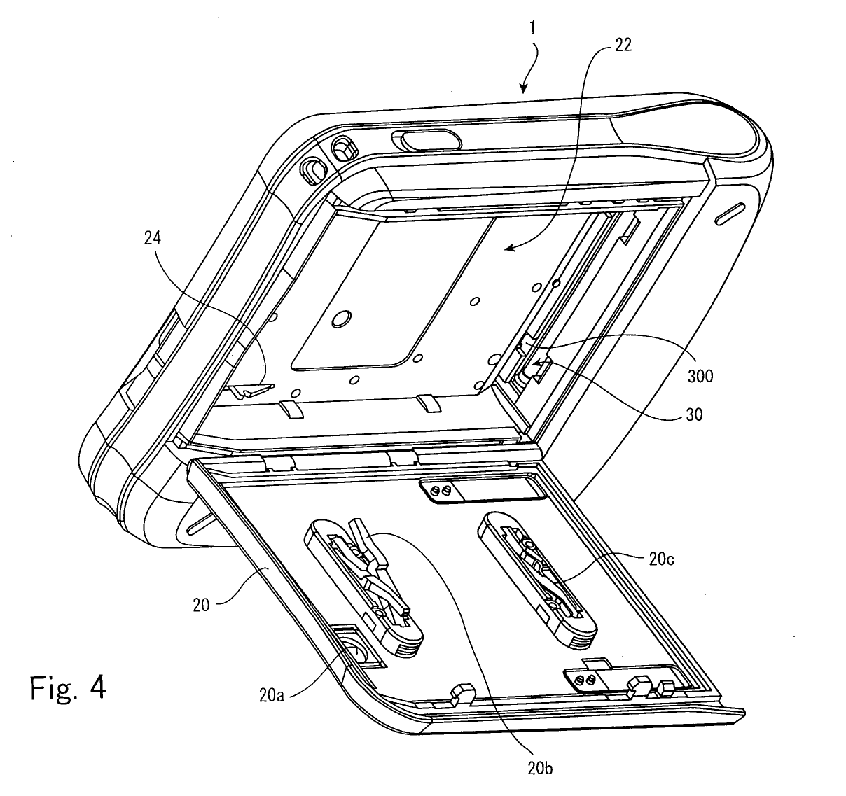

FIG. 4 is a perspective view of the printer in FIG. 3 with its film door open.

In addition to the pack confirmation window 20a described above, spring members 20b and 20c are provided on the inner side of the film door 20 to press the instant film sheets stacked in the instant film pack to the top face of the printer 1.

The printer 1 is equipped with a media compartment 22 to be loaded with an instant film pack. Outside the media compartment 22, in right part of the space of FIG. 4, there are an image write section 300 (an example of the fixed write head according to the present invention) and media transport section 30. In the media compartment 22, in a lower part of the space of FIG. 4, there is a claw 24 for use to send out instant film sheets to the image write section 300 and media transport section 30. With this configuration, the uppermost one of the instant film sheets in the instant film pack is pushed up by the claw 24 and transported by the media transport section 30, and in the meantime an image is recorded on it by the image write section 300.

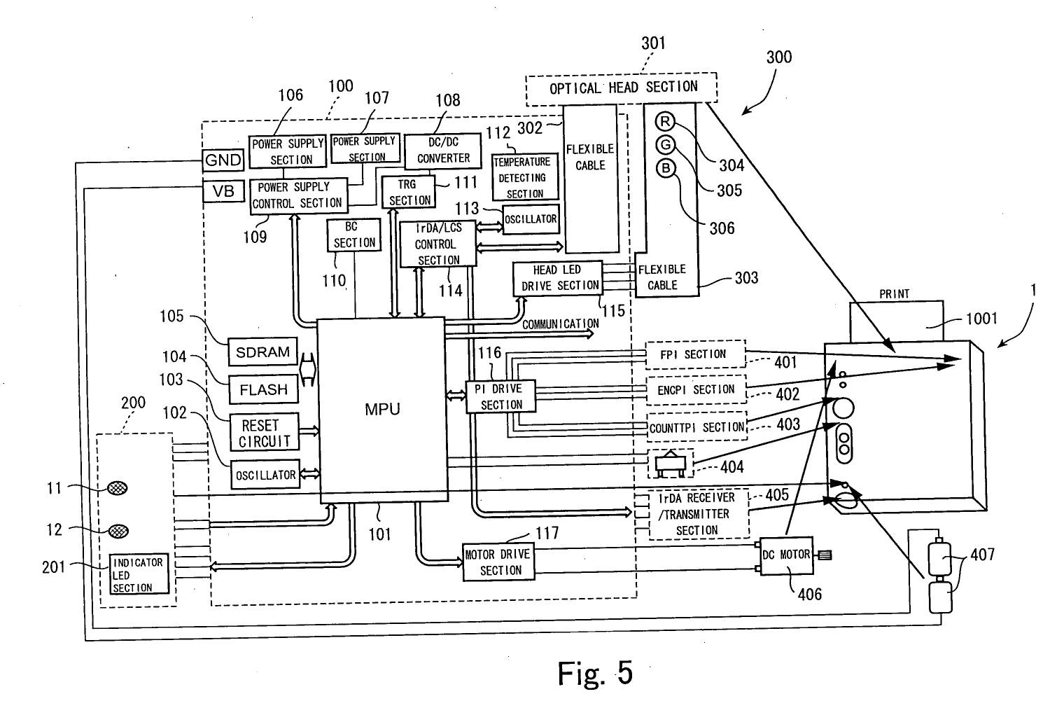

FIG. 5 is a block diagram showing a control system in the printer.

The entire area of FIG. 5 shows configuration of the control system of the printer 1 except for the right end which schematically shows the printer 1 shown in FIG. 1. Incidentally, the arrows in FIG. 5 indicate relative locations of components of the control system of the printer 1.

The printer 1 has a main board 100, a sub-board 200, the image write section 300, an FPI section 401, an ENCPI section 402, a COUNTPI section 403, a cam switch 404, an IrDA receiver/transmitter section 405 installed in the receiver/transmitter section 14, and a DC motor 406.

The sub-board 200 contains the power SW 11 and repeat SW 12 described above as well as an indicator LED section 201. The indicator LED section 201 includes the power LED 15, communications error LED 16, and low-battery indicator LED 17 described above as well as a counter backlight LED (not shown) mounted on the backside of the counter 13.

The image write section 300 is an example of the fixed write head according to the present invention. It includes an optical head section 301 equipped with an optical guide, liquid crystal shutter (LCS), etc.; flexible cables 302 and 303 which connect the optical head section 301 with the main board 100; and red (R), green (G), and blue (B) light-emitting elements (LED) 304, 305, and 306 mounted on the flexible cable 303. The image write section 300 writes a latent image on an instant film sheet being transported, by irradiating it with three color lights from the LEDs 304, 305, and 306 cyclically in synchronization with write command pulses, but details will be described later. The printer 1 contains two 3-volt primary batteries 407.

The main board 100 will be described below. A 6-volt power supply voltage VB is applied to the main board 100 from the primary batteries 407. The main board 100 is equipped with an MPU (Micro Processor Unit) 101, oscillator 102, reset circuit 103, flash memory (FLASH) 104, and SDRAM 105.

The MPU 101 totally controls the operation of the printer 1.

The oscillator 102 generates a predetermined oscillatory signal and supplies it as an operation clock signal to the MPU 101.

The reset circuit 103 outputs a reset signal to initialize the MPU 101.

The flash memory 104 is a non-volatile memory. It stores adjustment values and the like for adjustment of individual differences which vary with the mechanism and the like unique to the printer 1.

The SDRAM 105 is a volatile memory. It stores image data and the like received from the camera-equipped cell phone 2.

The main board 100 is equipped with a power supply section 106, power supply section 107, and DC/DC converter 108 which receive the 6-volt power supply voltage VB and output a 2.5-V voltage, 3.3-V voltage, and 15-V voltage, respectively. It is also equipped with a power supply control section 109 which controls the power supply sections 106 and 107 and the DC/DC converter 108 on instructions from the MPU 101. The 2.5-V voltage is supplied to the MPU 101 and the 3.3-V voltage is supplied to peripheral circuits other than the MPU 101. The 15-V voltage is used for LCD drive described later.

To prolong the life of the primary batteries 407, the MPU 101 of the printer 1 has a standby mode, which is a power saving mode. If the power SW 11 is pressed, the MPU 101 enters the standby mode after initialization is completed. In this state, if infrared communication is conducted from outside, the MPU 101 switches from standby mode to normal operation mode, records an image on an instant film sheet, and switches from normal operation mode to standby mode quickly. Also, when the repeat SW 12 is pressed, the MPU 101 records an image on an instant film sheet and then enters standby mode. The MPU 101 controls the power supply sections 106 and 107 and the DC/DC converter 108 via the power supply control section 109 so that power is supplied to various components only when necessary. This makes it possible to use the printer 1 on the built-in primary batteries 407 for a prolonged period of time.

Furthermore, the main board 100 is equipped with a BC section 110, TPG section 111, temperature detecting section 112, oscillator 113, IrDA/LCS control section 114, and head LED drive section 115.

The BC section 110 checks whether the power supply voltage VB of the built-in primary batteries 407 is lower than a predetermined value. If it is found, based on the results of the check, that the power supply voltage VB of the built-in primary batteries 407 is lower than the predetermined value, the MPU 101 illuminates the low-battery indicator LED 17, prompting the user to replace the batteries.

The TPG section 111 turns on and off the 15-V voltage outputted from the DC/DC converter 108.

The temperature detecting section 112 detects temperature of the image write section 300. The MPU 101 controls the shutter speeds and the like of shutter sections of the liquid crystal shutter in the optical head section 301 based on a detection signal from the temperature detecting section 112.

The oscillator 113 generates an oscillatory signal of a predetermined frequency and supplies it to the IrDA/LCS control section 114.

The IrDA/LCS control section 114 controls IrDA receiver/transmitter section 405 and optical head section 301 based on the oscillatory signal from the oscillator 113. The IrDA receiver/transmitter section 405 is equipped with a photo-transmitter and photo-receiver for infrared communication, and the IrDA/LCS control section 114 sends data produced by the photo-receiver as a result of photoelectric conversion to the MPU 101 and sends data from the MPU 101 via the photo-transmitter, notifying external devices to that effect. Also, the IrDA/LCS control section 114 controls the liquid crystal shutter of the optical head section 301 via the flexible cable 302 based on instructions from the MPU 101.

The head LED drive section 115 passes current through the LEDs 304, 305, and 306 via the flexible cable 303 based on instructions from the MPU 101, and thereby drives the LEDs 304, 305, and 306.

While feeding an instant film sheet in a predetermined sub-scanning direction (the feed direction of the instant film sheet) using the DC motor 406, the printer 1 according to this embodiment writes to the instant film sheet using three colors of RGB cyclically in the sub-scanning direction on, writes to all pixels arranged in the main scanning direction using the same color simultaneously in the main scanning direction orthogonal to the sub-scanning direction, and thereby records an image on the instant film sheet.

The optical head section 301 of the image write section 300 is supplied with a control signal form the IrDA/LCS control section 114 via the flexible cable 302 according to image data. The control signal controls the shutter speeds of the shutter sections of the liquid crystal shutter in the optical head section 301. The shutter speeds of the shutter sections are controlled according to the image data. Lights corresponding to the RGB colors of the LEDs 304, 305, and 306 mounted on the flexible cable 303 are directed at the instant film sheet, forming a latent image consisting of a large number of light spots (dots) on the instant film sheet along its width. The width direction along which shutter sections are arranged one-dimensionally corresponds to the main scanning direction. Thus, as shutter sections are scanned electronically in the main scanning direction, one line of light spots (all pixels) are recorded on the instant film sheet. That is, through electronic scanning by the optical head section 301, light spots consisting of a large number of dots are recorded in the main scanning direction on the instant film sheet. As described above, according to this embodiment, the instant film sheet is fed in the sub-scanning direction by the DC motor 406. Thus, light spots for a large number of dots are recorded sequentially in the sub-scanning direction as well by the image write section 300.

Furthermore, the main board 100 is equipped with a PI drive section 116, which drives the FPI section 401, ENCPI section 402, and COUNTPI section 403. Now, description will be given of the FPI section 401, ENCPI section 402, and COUNTPI section 403.

The FPI section 401 is a photointerrupter which detects the presence or absence of an instant film sheet and outputs a film signal FILM_PI described later. In the initial state in which instant film sheets are contained in the instant film pack, the FPI section 401 outputs the film signal FILM_PI in high (H) state. When an instant film sheet is transported by rotation of the DC motor 406 and its front end is detected, the film signal FILM_PI changes from high (H) to low (L). Then, when the instant film sheet continues to be transported and its rear end is detected, the film signal FILM_PI changes from low (L) to high (H).

The ENCPI section 402 is a photointerrupter which outputs an encoder signal ENC (described later) consisting of pulse trains synchronized with the rotation of the DC motor 406.

The COUNTPI section 403 is a photointerrupter which detects whether the counter 13 is reset (the instant film pack is pulled out).

Also, the main board 100 is connected with a cam switch 404, which is used to monitor the initial position of a transport mechanism of the printer 1. When the transport mechanism is at the initial position, the cam switch 404 outputs a cam switch signal CAMSW in high (H) state. When the transport mechanism leaves the initial position along with rotation of the DC motor 406, the cam switch signal CAMSW changes from high (H) to low (L).

Furthermore, the main board 100 is equipped with a motor drive section 117. The motor drive section 117 plays the role of the transport control section according to the present invention in conjunction with the MPU 101.

The printer 1 according to the present invention uses the primary batteries 407. Generally, primary batteries have high internal resistance to prevent spontaneous discharges. Consequently, variations in the current flowing through the primary batteries appear directly as variations in the output voltage of the primary batteries. Also, the printer 1 according to the present invention employs the DC motor 406. Thus, when writing into an instant film sheet 1001, to give a sufficient amount of light exposure to the instant film sheet 1001 stably, it is necessary to transport the instant film sheet 1001 not faster than at a predetermined speed. Also, it is necessary to reduce the duration of time for which an image is written onto the instant film sheet 1001.

For that, in this embodiment, the motor drive section 117 and MPU 101 which play the role of the transport control section supply power from the primary batteries 407 directly to the DC motor 406 to achieve a predetermined initial transport speed and high delivery transport speed, and convert the power of the primary batteries 407 into a predetermined voltage (4 V) lower than the voltage (6 V) of the primary batteries 407 and supply the resulting voltage to the DC motor 406 to achieve a low writing transport speed. Also, while the instant film sheet 1001 is being transported at the writing transport speed, the motor drive section 117 and MPU 101 control the rotational speed of the DC motor 406 so that pulse trains of the encoder signal are generated at predetermined time intervals. Incidentally, the control performed by the motor drive section 117 and MPU 101 will be described later.

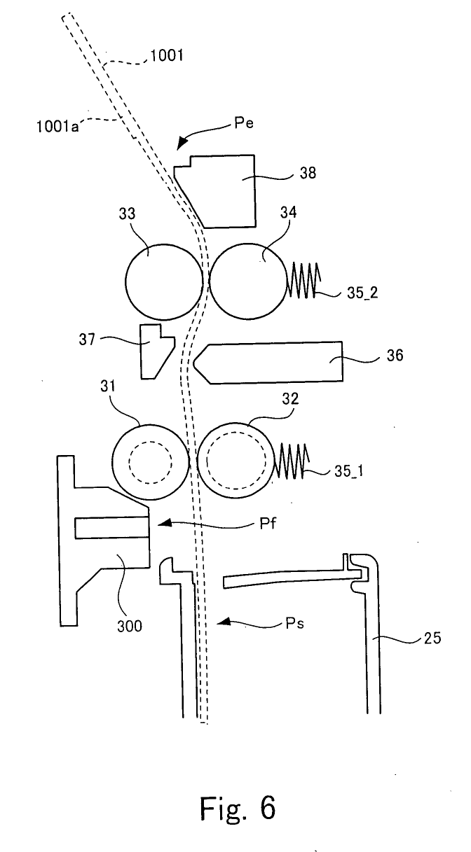

FIG. 6 is a sectional view showing a configuration of part of the media transport section.

The left side of FIG. 6 corresponds to the top face of the printer 1. The media transport section 30 is equipped with a pair of transport rollers 31 and 32 to transport an instant film sheet 1001 taken out of an instant film pack 25 by holding it from both sides. The transport roller 32 is urged toward the transport roller 31 by a spring member 35_1. Also, the media transport section 30 is equipped with a pair of distribution rollers 33 and 34 to distribute a developer by squeezing a developer pool 1001a of the instant film sheet 1001. The distribution roller 34 is urged toward the distribution roller 33 by a spring member 35_2. Furthermore, between the pair of transport rollers (31 and 32) and the pair of distribution rollers (33 and 34), the media transport section 30 is equipped with control plates 36 and 37 which control the developer being distributed as well as with a guide frame 38 which guides the instant film sheet 1001. Besides, the image write section 300 is installed near an exit of the instant film pack 25. The image write section 300 writes an image onto the instant film sheet 1001 being transported, at a predetermined fixed write point Pf.

The media transport section 30 transports the instant film sheet 1001 from a predetermined transport start point Ps to a predetermined transport end point Pe through the fixed write point Pf.

The motor drive section 117 and MPU 101 control the media transport section 30 so that the instant film sheet 1001 located at the transport start point Ps starts to be transported at an initial transport speed, that the transport speed is changed to a low writing transport speed before a predetermined writing start point on the instant film sheet 1001 reaches the fixed write point Pf, and that the transport speed of the recording medium is changed again to a delivery transport speed higher than the writing transport speed after a predetermined writing end point on the instant film sheet 1001 passes the fixed write point Pf. In this way, the printer 1 according to the present invention starts to transport the instant film sheet 1001 located at the transport start point Ps at an initial transport speed, changes the transport speed to a low writing transport speed before a predetermined writing start point on the instant film sheet 1001 reaches the fixed write point Pf, changes the transport speed again to a high delivery transport speed after the writing is completed, and then outputs the instant film sheet 1001. Consequently, the instant film sheet 1001 is transported at a high speed until writing is started, it starts to be transported at a low speed just before the writing is started so that the image is written onto it reliably, and then it is sent out at a high speed. This reduces the time required to produce a print while maintaining the quality of images written onto the instant film sheet 1001.

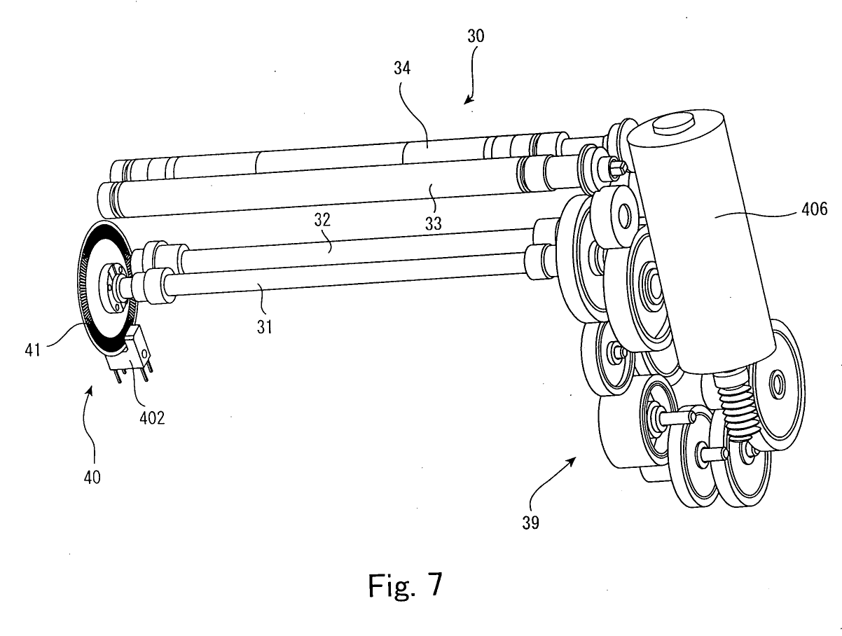

FIG. 7 is a perspective view of the media transport section.

The media transport section 30 shown in FIG. 7 is equipped with the pair of transport rollers 31 and 32 and the pair of distribution rollers 33, 34 described above. Also, the media transport section 30 is equipped with a gear train 39 which transmits the rotational drive force of the DC motor 406 to the transport rollers 31 and 32 and distribution rollers 33 and 34. Furthermore, the media transport section 30 is equipped with the ENCPI section 402 which is a transmissive photointerrupter consisting of a photo-transmitter and photo-receiver as well as with an encoder 40 which has a disk-shaped member 41. The disk-shaped member 41 is mounted on the transport roller 31. A large number of slots are provided in the disk-shaped member 41. As the disk-shaped member 41 rotates along with the rotation of the transport roller 31, the ENCPI section 402 receives lights from the photo-transmitter by means of the photo-receiver through the slots and thereby generates an encoder signal consisting of pulse trains synchronized with the transport roller 31.

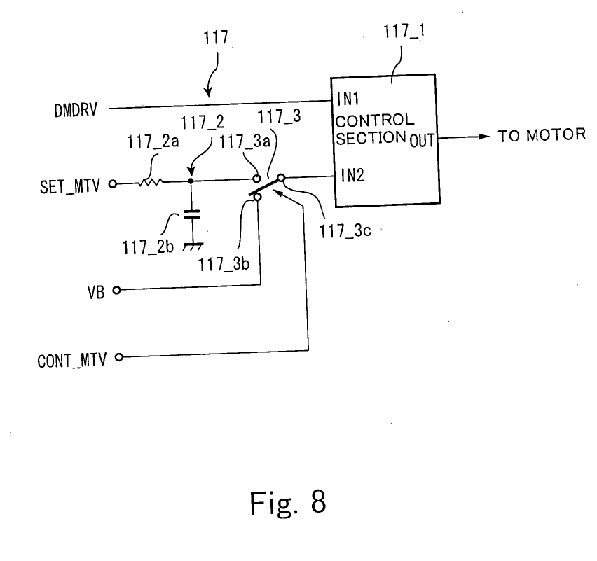

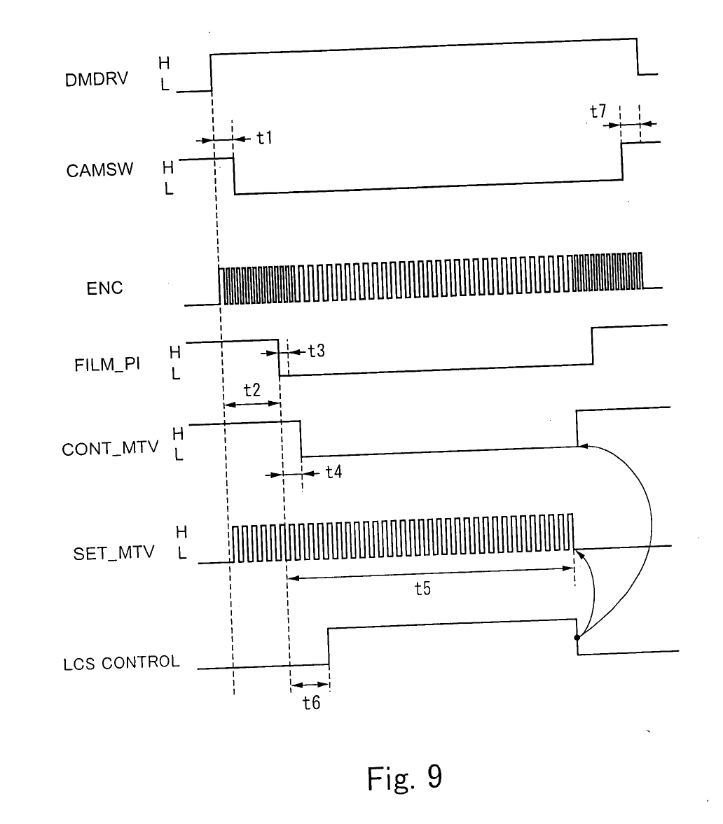

FIG. 8 is a diagram showing a circuit of the motor drive section shown in FIG. 5. FIG. 9 shows timing charts of the motor drive section shown in FIG. 8 and the MPU.

The motor drive section 117 shown in FIG. 8 is equipped with a control section 117_1, integration circuit 117_2, and switch circuit 117_3, where the integration circuit 117_2 consists of a resistive element 117_2a and capacitor element 117_2b while the switch circuit 117_3 consists of a contacts 117_3a, 117_3b, and 117_3c. The switch circuit 117_3 operates based on a motor control signal CONT_MTV from the MPU 101.

A motor drive signal DMDRV from the MPU 101 is entered in an input IN1 of the control section 117_1. A pulse signal SET_MTVDMDRV with a variable duty ratio is inputted in the integration circuit 117_2 from the MPU 101 to keep the rotation of the DC motor 406 constant. The 6-volt power supply voltage VB of the primary batteries 407 is applied to the contact 117_3b of the switch circuit 117_3.

As shown in FIG. 9, in the initial state, the motor drive signal DMDRV of the MPU 101 is low (L). The cam switch signal CAMSW from the cam switch 404 is high (H). The film signal FILM_PI from the FPI section 401 is high (H). The motor control signal CONT_MTV from the MPU 101 is high (H). Consequently, the contacts 117_3b and 117_3c of the switch circuit 117_3 are connected, allowing the 6-volt power supply voltage VB to be entered in an input IN2 of the control section 117_1.

Then, the motor drive signal DMDRV is changed from low (L) to high (H) by the MPU 101. In response, the control section 117_1 outputs the 6-volt power supply voltage VB entered in the input IN2 to the DC motor 406 through an output OUT. The DC motor 406, to which the 6-volt power supply voltage VB is applied, rotates at a high speed, causing the instant film sheet to be transported at a high initial transport speed. Also, an encoder signal ENC is outputted in synchronization with the rotation of the DC motor 406. Then, a pulse signal SET_MTV with a predetermined duty ratio is inputted in the integration circuit 117_2 from the MPU 101. The integration circuit 117_2 generates a control voltage corresponding to the duty ratio of the pulse signal SET_MTV.

After a lapse of time t1 from the time when the motor drive signal DMDRV changes from low (L) to high (H), the cam switch signal CAMSW changes from high (H) to low (L). Also, since the DC motor 406 is rotating at a high speed, the encoder signal ENC outputted in synchronization with the rotation of the DC motor 406 is relatively short.

After a lapse of time t2 longer than t1, the front end of the instant film sheet is detected and the film signal FILM_PI changes from high (H) to low (L). In response, the MPU 101 performs feedback control which involves monitoring the rotation of the DC motor 406 and changing the duty ratio of the pulse signal SET_MTV to keep the rotation of the DC motor 406 constant. The pulse signal SET_MTV under feedback control is inputted in the integration circuit 117_2. The integration circuit 117_2 generates control voltage according to the duty ratio. After a lapse of time t4 longer than chattering time t3 of the film signal FILM_PI from time t2, the MPU 101 changes the motor control signal CONT_MTV from high (H) to low (L). Consequently, the contact 117_3a and contact 117_3c of the switch circuit 117_3 are connected with each other, and a control voltage lower than the 6-volt power supply voltage VB determined by the integration circuit 117_2 is entered in the input IN2 of the control section 117_1. The control section 117_1 outputs the control voltage to the DC motor 406 from the output OUT. The DC motor 406 rotates at a low speed since the control voltage is applied to the DC motor 406. Consequently, the instant film sheet is transported at a low speed, that is, the writing transport speed.

After a lapse of time t6 longer than the time t4 from the time t2, liquid crystal shutter control (LCS control) is performed and the instant film sheet is written to as described above. When the LCS control is finished, the MPU 101 stops to output the pulse signal SET_MTV. Also, the MPU 101 changes the motor control signal CONT_MTV from low (L) to high (H). Consequently, the 6-volt power supply voltage VB is applied to the DC motor 406 to rotate the DC motor 406 at a high speed. Consequently, the instant film sheet is transported again at a high speed, the delivery transport speed. Then, the rear end of the instant film sheet is detected, and the film signal FILM_PI changes from low (L) to high (H). Subsequently, the cam switch signal CAMSW changes from low (L) to high (H). After a lapse of chattering time t7 of the cam switch signal CAMSW, the MPU 101 changes the motor drive signal DMDRV from high (H) to low (L). This ends a sequence of operations of the printer 1.

Incidentally, although in this embodiment, the present invention is applied to a printer which employs instant film, the present invention is not limited to this and can be applied to any printer that records color images on a recording medium by writing to a recording medium using multiple colors cyclically in a predetermined sub-scanning direction while a motor is feeding the recording medium on which the images are to be recorded, in the sub-scanning direction.

1. A printer which writes images on a recording medium while transporting the recording medium on which the images are to be recorded, comprising:
a fixed write head which writes an image on the recording medium being transported, at a predetermined fixed write point;
a media transport section which transports the recording medium from a predetermined transport start point to a predetermined transport end point through the fixed write point; and
a transport control section which controls the media transport section so that the recording medium located at the transport start point starts to be transported at an initial transport speed, that transport speed is changed to a low, writing transport speed before a predetermined writing start point on the recording medium reaches the fixed write point, and that the transport speed of the recording medium is changed again to a delivery transport speed higher than the writing transport speed after a predetermined writing end point on the recording medium passes the fixed write point.

2. The printer according to claim 1, wherein:
the recording medium is transported by a DC motor which draws power from built-in batteries; and
the transport control section develops the initial transport speed and the delivery transport speed by supplying power directly to the DC motor from the built-in batteries and develops the writing transport speed by converting the lower of the built-in batteries into a predetermined voltage lower than voltage of the built-in batteries and supplying the resulting voltage to the DC motor.

3. The printer according to claim 1, wherein:
the transport control section comprises an integration circuit including a resistor and capacitor, provides a pulse train signal with a variable duty ratio to the integration circuit, and supplies the DC motor with power proportional to DC voltage obtained through integration carried out by the integration circuit while the recording medium is transported at the writing transport speed.

4. The printer according to claim 1, wherein:
the media transport section comprises a transport roller which rotates to transport the recording medium, being driven by the DC motor, and an encoder which generates an encoder signal consisting of pulse trains in synchronization with the rotation of the transport roller; and
the transport control section controls rotational speed of the DC motor so that the pulse trains of the encoder signal is generated at predetermined time intervals while the recording medium is transported at the writing transport speed.

5. The printer according to claim 1, comprising:
a media compartment loaded with a recording medium on which a latent image is formed by exposure and then visualized by developing,
wherein the media transport section transports the recording medium loaded in the media compartment, which serves as the transport start point; and
the fixed write head writes a latent image into the recording medium by irradiating the recording medium being transported, with a plurality of color lights cyclically.
